(19) United States
(12) Patent Application Publication
(10) Pub. No.: US 2010/0114861 A1
(43) Pub. Date: May 6, 2010

(54) SYSTEM AND METHOD FOR INFORMATION ACQUISITION

(75) Inventors: YONG-HUI XIAO, Shenzhen City (CN); MIN YANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/464,525

(22) Filed: May 12, 2009

(30) Foreign Application Priority Data
Oct. 16, 2008 (CN) 200810304950.8

(51) Int. Cl. G06F 17/30; G06F 3/048; G06F 7/00; G01S 1/00

(52) U.S. Cl. 707/709; 715/810; 342/357.06; 707/918

(57) ABSTRACT

A system for information acquisition includes a Global Positioning System (GPS) receiver for determining a current location, a search module connected to the GPS receiver, and a configuration module connected to the search module. At least one request item is stored in the configuration module. The search module is configured for requesting and acquiring associated information with the current location according to the request item to and from an information center through the Internet.

### BACKGROUND

1. Technical Field

The present disclosure relates to a system and a method for automatic acquisition of information.

2. Description of Related Art

Mobile terminals are in widespread daily use. When a user of a mobile terminal arrives in an unknown location, acquisition of associated local information such as weather forecasts, customs, events recently, and others through the mobile terminal can be difficult and complicated.

What is needed, therefore, is a system and a method for automatic acquisition of information.

### BRIEF DESCRIPTION OF THE DRAWINGS

FIG. 1 is a schematic diagram of a system for information acquisition.

FIG. 2 is a flowchart of a method for information acquisition.

### DETAILED DESCRIPTION

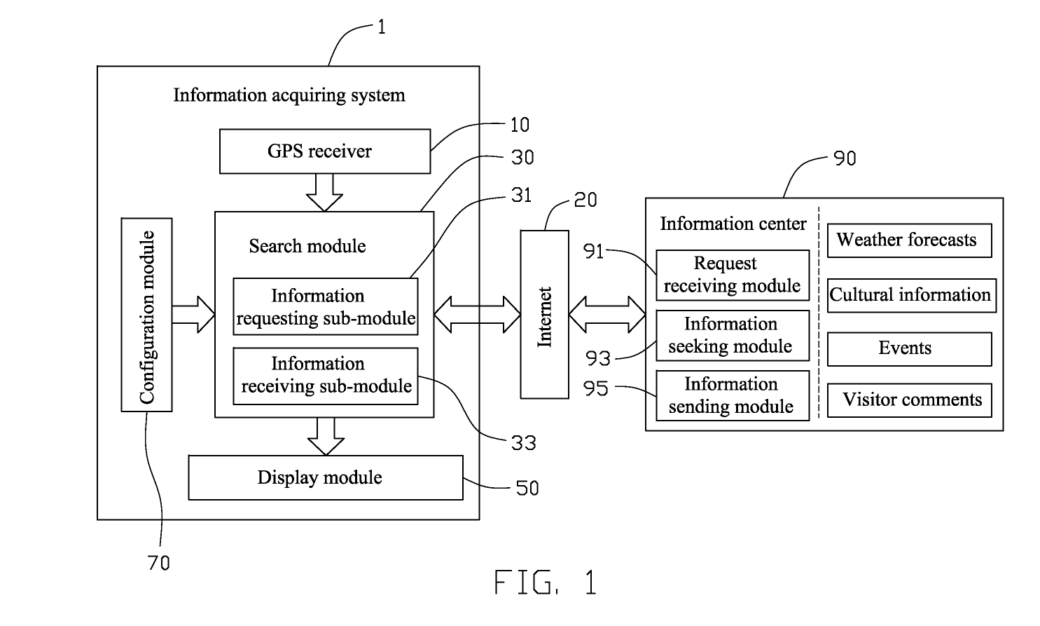

Referring to FIG. 1, an information acquisition system 1 includes a GPS receiver 10, a search module 30 connected to the GPS receiver 10, a configuration module 70 connected to the search module 30, and a display module 50. The search module 30 is connected to an information center 90 through the Internet 20.

The GPS receiver 10 determines a current location of the user. The configuration module 70 sets items requested by the user. The search module 30 seeks the information associated with the current location according to the requested items set in the configuration module 70, and the search module 30 includes an information requesting sub-module 31 and an information receiving sub-module 33. The display module 50 displays the associated information located by the search module 30. The associated information for various locations is stored in the information center 90, including weather forecasts, cultural information, events, visitor comments, and others. The request items in the configuration module 70 can be selected from a request item menu including request items of weather forecasts, cultural information, events, visitor comments, and others. The information center 90 includes a request receiving module 91, an information seeking module 93, and an information sending module 95.

The information acquisition system 1 is applicable in a mobile phone or car. Request items are entered in the configuration module 70. Request item categories can be preset such that the user always request weather data for example. Then, upon arrival in a new location, the GPS receiver 10 of the information acquisition system 1 determines the current location and transmits the result to the search module 30. The information requesting sub-module 31 of the search module 30 transmits corresponding request information to the information center 90 through the Internet 20 according to the request items in the configuration module 70 and the current location. When the request receiving module 91 receives the request information, the information seeking module 93 seeks the information associated with the current location in the information center 90, and the information sending module 95 transmits the results to the information receiving sub-module 33 through the Internet 20. The information receiving sub-module 33 transmits the associated information to the display module 50. The display module 50 displays the information associated with the current location, thereby conveniently acquiring the associated information. For example, to obtain a weather forecast and/or visitor comments for the current location, the information center 90 locates and sends the corresponding information.

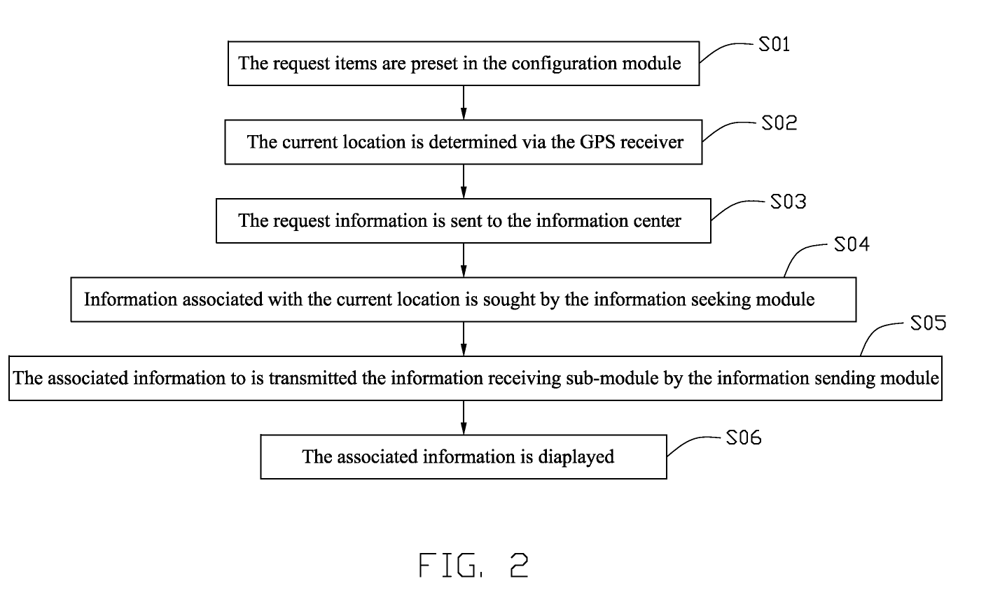

Referring to FIG. 2, a flowchart of a method for information acquisition includes the following steps:

In step S01, the request items are preset in the configuration module 70;
In step S02, the current location is determined via the GPS receiver 10;
In step S03, the request information is sent to the information center 90 through the Internet 20 by the information requesting sub-module 31 of the search module 30 according to the request items in the configuration module 70 and the current location;
In step S04, information associated with the current location is sought by the information seeking module 93 of the information center 90 when the request receiving module 91 receives the request information;
In step S05, the associated information is transmitted to the information receiving sub-module 33 of the search module 30 through the Internet 20 by the information sending module 95 of the information center 90;
In step S06, the associated information is transmitted to the display module 50 by the information receiving sub-module 33, and the associated information is displayed on the display module 50.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A system for information acquisition, comprising:
a Global Positioning System (GPS) receiver for determining a current location;
a search module connected to the GPS receiver; and
a configuration module connected to the search module and having at least one request item stored therein;
wherein the search module is capable of acquiring local information from an information center through the Internet according to the request item in the configuration module.

2. The system of claim 1, wherein the request item is selected from a request item menu, the request item menu consists of at least one of weather forecasts, cultural information, events, and visitor comments.

3. The system of claim 1, wherein the search module comprises an information requesting sub-module and an information receiving sub-module; the information requesting sub-module is capable of sending a request to the information center according to the request item in the configuration module and the current location, the information receiving sub-module is capable of receiving the local information from the information center.

4. The system of claim 3, further comprising a display module capable of displaying the local information received by the information receiving sub-module.

5. A method for information acquisition, comprising:
storing a request item in a configuration module;
determining a current location through a Global Positioning System (GPS) receiver;
acquiring associated information with the current location based on the request item from a remote information center; and
displaying the associated information.

6. The method of claim 5, wherein the request item is entered through a configuration module.

7. The method of claim 6, wherein the acquiring associated information with the current location is performed by a search module, the search module automatically acquires the associated information with the current location.

8. The method of claim 7, wherein the search module comprises an information requesting sub-module and an information receiving sub-module; the information requesting sub-module sends a request for information to the information center according to the request item in the configuration module and the current location, the information receiving sub-module receives the associated information with the current location from the information center.

9. The method of claim 8, wherein the request item is selected from a request item menu, the request item menu consists of at least one of weather forecasts, cultural information, events, and visitor comments.

10. The method of claim 8, wherein the search module is connected to a display module, the display module displays the associated information with the current location.
